(19) United States
(12) Patent Application Publication
(10) Pub. No.: US 2025/0155338 A1
(43) Pub. Date: May 15, 2025

(54) PARTICLE-PACKED MEMBRANE INLET FOR HIGH-PRESSURE CHEMICAL MEASUREMENTS

(71) Applicant: Beaver Creek Analytical, LLC, Lafayette, CO (US)

(72) Inventor: Ryan Bell, Lafayette, CO (US)

(21) Appl. No.: 18/839,689

(22) PCT Filed: Feb. 10, 2023
(86) PCT No.: PCT/US23/62442

§ 371 Date: Aug. 19, 2024

Related U.S. Application Data
(60) Provisional application No. 63/267,906, filed on Feb. 11, 2022.

(51) Int. Cl. G01N 1/40; B01D 61/14

(52) U.S. Cl. CPC G01N 1/4005; B01D 61/14

(57) ABSTRACT

A particle-packed membrane inlet (PPMI) for in situ separation of an analyte from a bulk sample matrix is disclosed. The PPMI includes a membrane configured to separate the analyte from the bulk sample matrix, a membrane capillary within the membrane, and a plurality of particles packed within the membrane capillary. The plurality of particles is configured to support the membrane capillary against collapse when the bulk sample matrix has a high pressure.

### CROSS-REFERENCE TO RELATED APPLICATIONS

The application claims priority under 35 U.S.C. § 119 (e) to U.S. Provisional Patent Application No. 63/267,906, titled “PARTICLE-PACKET MEMBRANE INLET FOR CHEMICAL ANALYSIS,” filed on Feb. 11, 2022, which is herein incorporated by reference in its entirety.

### BACKGROUND

### 1. Field

The present disclosure relates in general to systems and methods for performing measurements for chemical analysis, and more specifically, to system and methods for performing in situ measurements at high pressures.

### 2. Related Art

At present, measurements of dissolved gases by membrane separation are an important way of performing chemical analysis on liquids and gases having chemical atoms, or molecules (i.e., species) that need to have an analyte (i.e., a chemical species that is a substance or chemical constituent that is of interest in an analytical procedure) separated and measured from a bulk sample matrix (i.e., the components of the sample other than the analyte of interest).

As an example, the detection of dissolved gases in seawater plays an important role in oceanic observations and exploration and is essential for studying the ocean's environment and ecosystem. CO₂ is a key factor in global warming, and O₂ is an important sign of net biological oxygen production. There is a certain relationship between CO₂ and O₂ in primary production (photosynthesis and chemosynthesis) and secondary production (respiration). Dissolved H₂ is a key parameter of thermodynamic equilibria and kinetic processes in water-rock interactions process. Thus, there is significant scientific and environmental value in tracking the concentrations of dissolved gases in the ocean. However, the low concentrations of dissolved gases and the complex oceanic environment are significant challenges for in situ dissolved gases sensors.

As another example, monitoring volatile compounds (i.e., substances capable of readily changing from a solid or liquid form to a vapor) in sewer systems is of high importance because of the toxic and corrosive nature of various nuisance chemicals that are generated in sewer systems such as, for example, hydrogen sulfide (H₂S). By monitoring and identifying the presence and location of any generated H₂S, targeted treatment can be applied to this location that eventually minimizes the use of chemicals and lowers the environmental effect within the sewer system.

Moreover, as another example, monitoring volatile organic compounds (e.g., natural gas and other light hydrocarbons) dissolved in water bodies provide as important industrial and commercial interest with respect to the environmental monitoring of offshore oil and gas infrastructure and exploration of oil and gas resources.

A problem exists, however, when ratiometric measurement tools are utilized for in situ chemical analysis. In general, in situ means “in the reaction mixture” or “operations or procedures that are performed in place” and in the chemical field there are numerous situations in which chemical intermediates are synthesized in situ in various processes. This may be done because the species is unstable, and cannot be isolated, or simply out of convenience.

Examples of in situ chemical analysis include performing chemical analysis with sensitivity and specificity where the chemical species of interest needs to be separated from the bulk sample matrix (as an example, in sample pre-concentration). Moreover, many means of chemical analysis require that the chemical species be in a gas phase (needing for sample vaporization of the chemical species). A problem is that in situ and online (also known as continuous) chemical analysis procedures necessitate that the two steps of sample pre-concentration and vaporization be performed with limited or no sample preparation.

Current approaches to solve this problem include the utilization of a thin membrane (known as a membrane inlet) that extracts and volatizes (i.e., cause to evaporate or disperse in vapor) the gaseous or aqueous sample hydrophobic substances (i.e., substances that are composed of non-polar molecules that repel bodies of water and attract other neutral molecules and non-polar solvents) via pervaporation through the thin membrane. As such, membrane inlets are a popular choice for online and in situ analysis because membrane inlets achieve these goals by a simple means. A problem with these known membrane inlets is that in situations where a sample is under high pressure, the membrane inlet needs to be supported against a pressure differential while also allowing a gas to pass beyond the membrane to a region of analysis at an analyzer, as shown in FIG. 1.

In FIG. 1, a system block diagram of an example of a measurement system 100 having a membrane inlet 102 and an analyzer 104. The membrane inlet 102 may be physically connected to the analyzer 104 via a connecting fluidic tube 106. The membrane inlet 100 includes a cavity 108, a sample inlet 110, a sample outlet 112, membrane capillary 114, thermocouple 116, and volatile analyte 118 (such as permanent gases or volatile organic carbons VOCs). The membrane inlet 100 also includes a known membrane physical support 120 surrounding the membrane capillary 114. In this example, the membrane capillary 114 might be supported by the membrane's inherent strength, itself, or the membrane physical support 120, where the membrane physical support 120 may include wound wire, sintered materials, or perforated materials that is located in the interior cavity of the surface of the membrane.

The analyzer 104 may be, for example, a spectroscopy analyzer or mass spectrometer that utilizes mass spectrometry (MS) and may include a vacuum chamber 122 having an electron source 124, an accelerator section 126, deflection electromagnets 128, outlet 130 to a vacuum pump, and a detector 131.

MS is an analytical technique that is used to measure the mass-to-charge ratio (m/z) of ions. The results are presented as a mass spectrum, a plot of intensity as a function of the mass-to-charge ratio. MS is used in many different fields and is applied to pure samples as well as complex mixtures because MS is known to be a versatile and powerful chemical sensing technique.

Generally, in MS systems (also known as mass spectrometers), like analyzer 104, analytes are transported from their normal state (e.g., solid phase or solution) into the vacuum chamber 122 of the mass spectrometers through a sample interface. After entering the vacuum chamber 122, ionized analytes 132 are then dispersed according to their m/z by some combination of electrical and magnetic fields 134 produced by the electromagnets 128. The ion signal is recorded as a function of mass-to-charge ratio, typically using a high-gain electron multiplier or Faraday-cup detector (e.g., detector 126) and the measured intensities for each m/z result in the mass spectrum and can often be related to the concentration of the analyte in the original sample, or possibly be used for identification of unknowns in a complex mixture. Mass spectrometers are, therefore, utilized in many fields of science and engineering.

In this example, the membrane inlet 102 allows for continuous introduction of multiple volatile species 118 with no sample preparation. Moreover, the analyzer 104 utilizing MS allows for sensitive simultaneous detection of multiple chemical species with high specificity.

In FIG. 2, a system diagram of an example of another known approach for a membrane inlet utilizing physical support structure 200 is shown. In this example, the membrane inlet 100 is within the support structure 200. The support structure 200 includes a housing 202 where the membrane inlet 102 is located. The housing 202 includes a heater block 204, the sample input (sample inlet) 206, and a sample output (sample outlet) 208. In this example, the sample inlet 206 wraps around the heater block 204 and the heater block 204 is in physical contact with the thermocouple 210 and heat cartridges 212. The housing 202 is also in physical contact with a connecting tube 214 that physically connects the membrane inlet to the analyzer. The connecting tube 214 includes a PEEK cap 216, sintered rod 218, and PDMS membrane 220. In this example, the heater block 204 allows the sample to be temperature regulated using the thermocouple and heater cartridge.

The problems with these known approaches are that when analyzing samples at very high to enormous pressures (e.g. in situ oceanic analysis) the membrane support structure must be very strong, have very small pore size, and be sufficiently durable (non-brittle). Moreover, it is also desirable to have membrane supports of varying sizes. Furthermore, current membrane support structures have the following problems: self-support membranes do not support against a large pressure differential; wound wire members do not support against a large pressure differential; perforated materials membranes have the problem that perforations cannot be made small enough for very large pressure differentials and, therefore, thick membranes are required; and sinter material membranes are too brittle when made in large geometries. As such, there is a need for a system and method that solves these problems.

### SUMMARY

A particle-packed membrane inlet (PPMI) for in situ separation of an analyte from a bulk sample matrix is disclosed. The PPMI includes a membrane configured to separate the analyte from the bulk sample matrix, a membrane capillary within the membrane, and a plurality of particles packed within the membrane capillary. The plurality of particles are configured to support the membrane capillary against collapse when the bulk sample matrix has a high pressure.

In an example of operation, the PPMI performs a method for in situ separation of the analyte from the bulk sample matrix. The method includes passing the bulk sample matrix along the outer surface of the membrane having the membrane capillary with the membrane; separating the analyte from the bulk sample matrix by diffusing the analyte through the membrane into the membrane capillary; and transporting the analyte from the membrane capillary through the packed plurality of particles.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of a known approach for a membrane inlet utilizing physical support.

FIG. 2 is a system diagram of an example of another known approach for a membrane inlet utilizing physical support.

FIG. 3 is a system block diagram of an example of an implementation of a particle-packed membrane inlet (PPMI) within a measurement system is shown in accordance with the present disclosure.

FIG. 4 is a zoomed-in view of the membrane the shown in FIG. 3 in accordance with the present disclosure.

FIG. 5 is a zoomed-in view of the membrane the shown in FIG. 3, where the PPMI further includes a structural support-rod physically and externally attached the outer surface of the membrane in accordance with the present disclosure.

FIG. 6 is a zoomed-in view of the membrane the shown in FIG. 3, where the PPMI further includes a structural center-rod in accordance with the present disclosure.

FIG. 7 is a side-view of an example of an implementation of a structural particle-packed membrane capillary in accordance with the present disclosure.

FIG. 8 is a side-view of an example of another implementation of a structural particle-packed membrane capillary in accordance with the present disclosure.

FIG. 9 is a side-view of an example of another implementation of a structural particle-packed membrane capillary in accordance with the present disclosure.

FIG. 10 is a side-view of an example of another implementation of a structural particle-packed membrane capillary in accordance with the present disclosure.

FIG. 11 is a side-view of an example of another implementation of a structural particle-packed membrane capillary in accordance with the present disclosure.

FIG. 12 is a block diagram of the membrane capillary, shown in FIGS. 3-11, with the plurality of particles being significantly smaller than the diameter of the membrane capillary of the membrane in accordance with the present disclosure.

FIG. 13 is a system block diagram of the membrane capillary, shown in FIGS. 3-11, with the plurality of particles being approximately equal to the diameter of the membrane capillary of the membrane in accordance with the present disclosure.

FIG. 14 is a flowchart is shown of an example of implementation of method performed by the PPMI in accordance with the present disclosure.

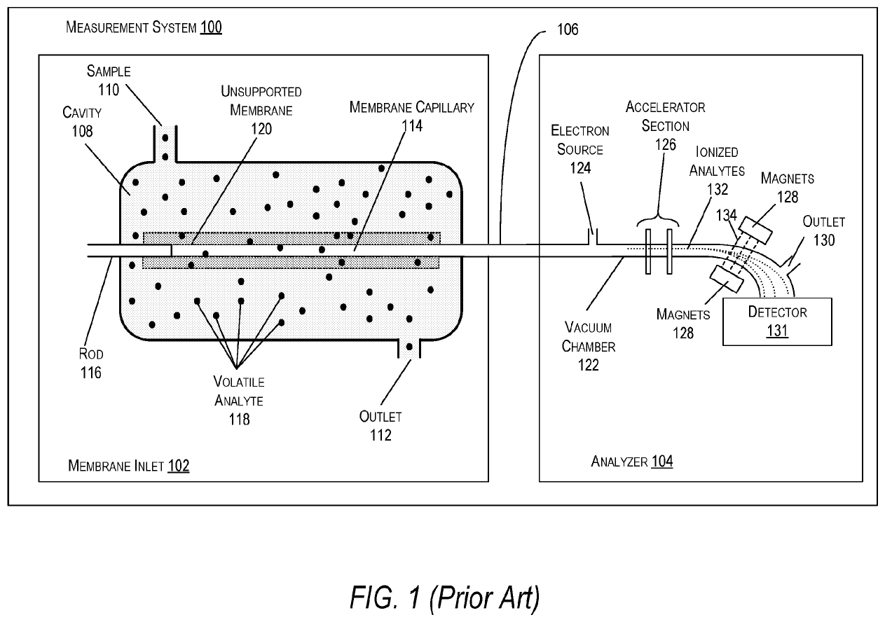

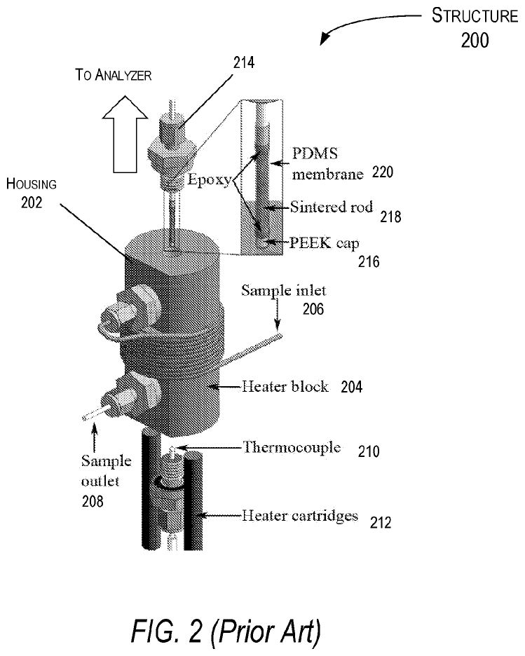

### DETAILED DESCRIPTION

Disclosed is a particle-packed membrane inlet (PPMI) for in situ separation of an analyte from a bulk sample matrix. The PPMI includes a membrane configured to separate the analyte from the bulk sample matrix, a membrane capillary within the membrane, and a plurality of particles packed within the membrane capillary. The plurality of particles are configured to support the membrane capillary against collapse when the bulk sample matrix has a high pressure.

In an example of operation, the PPMI performs a method for in situ separation of the analyte from the bulk sample matrix. The method includes passing the bulk sample matrix along the outer surface of the membrane having the membrane capillary with the membrane; separating the analyte from the bulk sample matrix by diffusing the analyte through the membrane into the membrane capillary; and evacuating the analyte from the membrane capillary through the packed plurality of particles.

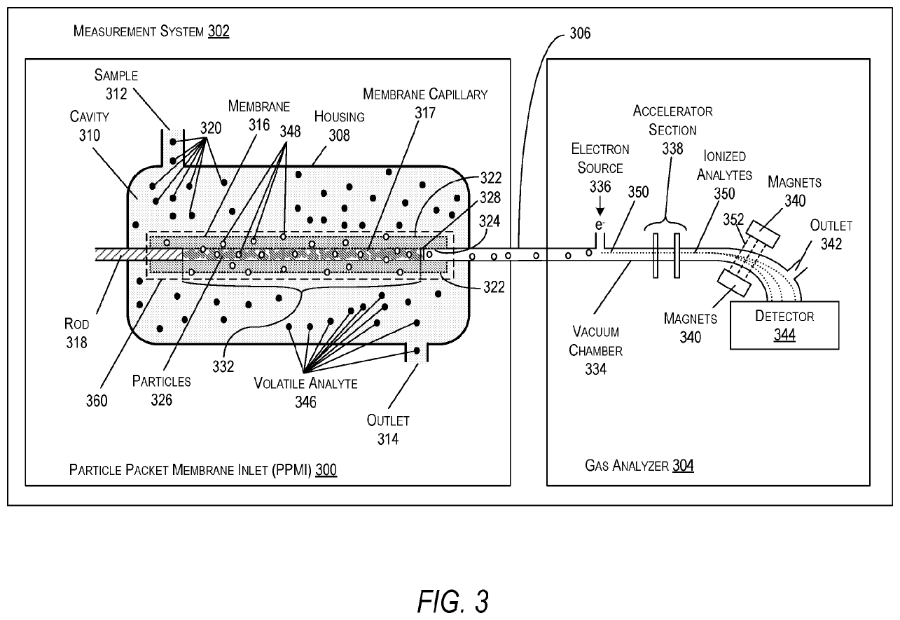

Turning to FIG. 3, a system block diagram of an example of an implementation of a PPMI 300 within a measurement system 302 is shown in accordance with the present disclosure. In this example, the PPMI 300 is shown in fluidic communication with a detector sensor, such as a gas analyzer 304, via connecting fluidic tube 306.

The PPMI 300 includes a housing 308, cavity 310 within the housing 308, a sample inlet 312, a sample outlet 314, membrane 316, membrane capillary 317, a rod 318 or plug (which can be a temperature measuring device such as, for example, a thermocouple), and a plurality of particles 320 packed within the membrane capillary 317. In this example, membrane 316 is approximately cylindrical in shape having a membrane outer surface 322 and a membrane inner surface 324. The membrane inner surface 324 defines a membrane cavity that is a lumen extending the length of the membrane 316. In this example, the lumen defining the membrane cavity is the membrane capillary 317. Additionally, the membrane capillary 317 is packed with a plurality of particles 326 that are packed against the membrane inner surface 324. The membrane capillary 317 may include a porous restriction 328 and the rod 318, opposite the porous restriction 328 and along a predetermined length of the membrane capillary 317. In this example, the porous restriction 328 and the rod 318 define particle section 332 within the membrane capillary 317. The porous section 328 and rod 318 are configured to restrict the movement of the plurality of particles 326 within the particle section 332 away from the particle section 332.

In general, the PPMI 300 is configured to separate one or more analytes (i.e., a chemical species that is a substance or chemical constituent that is of interest in an analytical procedure) from a bulk sample matrix (i.e., the components of the sample other than the analyte of interest). The chemical species may include chemical atoms, or molecules.

The analyzer 304 is a sensor capable of measuring the dissolved analytes that have been separated and volatilized from the bulk sample matrix by the PPMI 300. The analyzer 304 may be numerous type of analyzers capable of measuring the analytes that have been separated by the PPMI 300. As an example, the analyzer 104 may be, a mass spectrometer that utilizes mass spectrometry (MS) and may include a vacuum chamber 334 having an electron source 336, an accelerator section 338, deflection electromagnets 340, vacuum chamber outlet 342 to a vacuum pump (not shown), and a detector 344. In this example, the vacuum chamber 334 is fluidically connected to the membrane capillary 317 via the connecting fluidic tube 306.

MS is an analytical technique that is used to measure the mass-to-charge ratio (m/z) of ions. The results are presented as a mass spectrum, a plot of intensity as a function of the mass-to-charge ratio. MS is used in many different fields and is applied to pure samples as well as complex mixtures because MS is known to be a versatile and powerful chemical sensing technique.

As an example of operation, the cavity 310 of the PPMI 300 is filled with a bulk sample matrix (herein simply referred to as a sample) having volatile analytes 346. Typically, the sample is input into the cavity 310 via the sample inlet 312 and is output via the sample outlet 314. In an in situ analysis, the sample may be flushed continuously through the sample inlet 312, cavity 310, and sample outlet 314 at a predetermined pressure.

In general, water or gas can pass along the outer surface 322 of the membrane 316. When a molecule of the sample makes contact with the outer surface 322 of the membrane 316, it will diffuse through the membrane 316 and enter the membrane capillary 317. Generally, this process includes the molecule dissolving at the outer surface 322 of the membrane 322 and then diffusing through the body of the membrane 316 to evaporate into the membrane capillary 317 that includes an “air space” within the membrane 316 that is packed with the plurality of particles 326. When the air space is evacuated by a vacuum pump (not shown) or flushed by a carrier gas, the molecule will travel rapidly along the membrane capillary 317 towards the analyzer 304.

As such, in this example, some of the volatile analyte 346 is dissolved along the outer surface 322 of the membrane 316 to produce an analyte 348 that is diffused into the membrane capillary 317. The analyte 348 is then evacuated or flushed along the membrane capillary 317, connecting fluidic tube 306, and vacuum chamber 334 to the analyzer 304. Once in the vacuum chamber 334 of the analyzer 304, the analyte vapors 348 are ionized with the electron source 336 that may be, for example, an electron beam. Once ionized, the resulting ionized analyte vapors 350 are deflected with an electromagnetic filed(s) 352 produced by the deflection electromagnets 340. The air is evacuated from the vacuum chamber 334 via the vacuum chamber outlet 342 to a vacuum pump (not shown). The deflected ionized analyte vapors 350 are then detected at the detector 344 that measures the presence and mass-to-charge of the ionized analyte vapors 350. As an example, the detector 344 may be a Faraday-cup detector. The results are presented as a mass spectrum that is a plot of intensity as a function of the mass-to-charge ratio. The measured intensities for each mass-to-charge result in the mass spectrum and can often be related to the concentration of the analyte 346 in the original sample, compared ratiometrically among various simultaneously permeating analytes or possibly be used for identification of unknowns when the sample is a complex mixture.

The disclosed PPMI 300 is a physical structure capable of sustaining very high pressures from the bulk sample matrix. The packing of the plurality of particles 326 within the membrane capillary 317 prevent the collapse of the membrane cavity within the membrane 316 by applying a resistance force against the pressures asserted on the membrane 316.

In this example, the particles of the plurality of particles 326 may be grains, powders, beads, or other similar small physical objects that may be inserted into the membrane capillary 317 to physically support the membrane capillary 317 from collapsing under high pressures asserted by the bulk sample matrix. The particles 326 may be constructed of metal, plastic, rubber, ceramic, rock, or other rigid materials that may be packed into the membrane capillary 317 and allow for the evacuation or flushing of the analyte vapors 348 towards the analyzer 304, while preventing the physical collapse of the membrane capillary 317 under high pressure.

In this example, each grain, of the plurality of grains, may have a heterogenous grain size configured to optimize a maximum pressure differential and analyte transport. Moreover, each grain of the the plurality of grains may include activated grain surfaces configured to interact with the analyte.

As discussed earlier, the membrane 316 and membrane capillary 317 may include the particle section 332 that is defined by the first porous restriction 328 and the rod or plug 318, opposite the first porous restriction 328 and along the predetermined length of the membrane capillary 317. As the membrane 316 is a tube or lumen, as the housing 308, the length of the packed section can be selected with great variability. When used in conjunction with gas analyzers that cannot handle a lot of gas might be a few millimeters, but if a large gas flow can be accommodated by the analyzer (or mitigated pre-analyzer) then a very long section of packed membrane 316 can be used. As extremely long membranes allow a large amount of analyte to pass, this may enable very sensitive detection limits or enable the near complete degassing of the sample 312 itself. The packed section of a membrane might be as much as several meters.

As discussed earlier, the membrane 316 and membrane capillary 317 may include the particle section 332 that is defined by the first porous restriction 328 and the second porous restriction 330, opposite the first porous restriction 328 and along the predetermined length of the membrane capillary 317. As previously discussed, the first porous section 328 and second porous section 330 are configured to restrict the movement of the plurality of particles 326 within the particle section 332 away from the particle section 332. Specifically, the porous section 328 may be a screen or frit type device that allows the analyte vapors 348 to be evacuated towards the analyzer 304 but prevents any of the plurality of particles to be pulled into the analyzer 304. Similarly, the rod or plug 318 may be configured to be a thermocouple (or similar temperature measuring device) to enable accurate temperature measurements and provide feedback for temperature control using a heater. Warming sample improves analyte response times by increasing diffusion rates through the membrane. Optionally, the rod or plug 318 can replace by a porous section to prevent particles to escape into the cavity 310, this enables the introduction of a carrier gas to transport the analytes out of the capillary and to the analyzer.

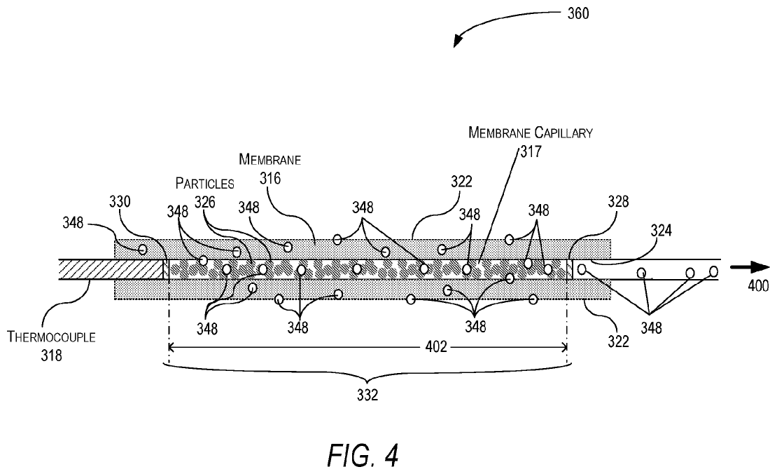

In FIG. 4, a zoomed-in view 360 of a membrane 316 is shown in accordance with the present disclosure. This zoomed-in view 360 allows for easier illustration of how the plurality of particles 326 are packed in the membrane capillary 317 and how the analyte vapors 348 are diffused through the outer surface 322 of the membrane 316 into the membrane capillary 317. The analyte vapors 348 are then evacuated in a direction 400 towards the analyzer 304. In this example, the particle section 332 may be a small, predetermined length 402 such as, for example, two millimeters or a large predetermined length 402 such as 2 meters.

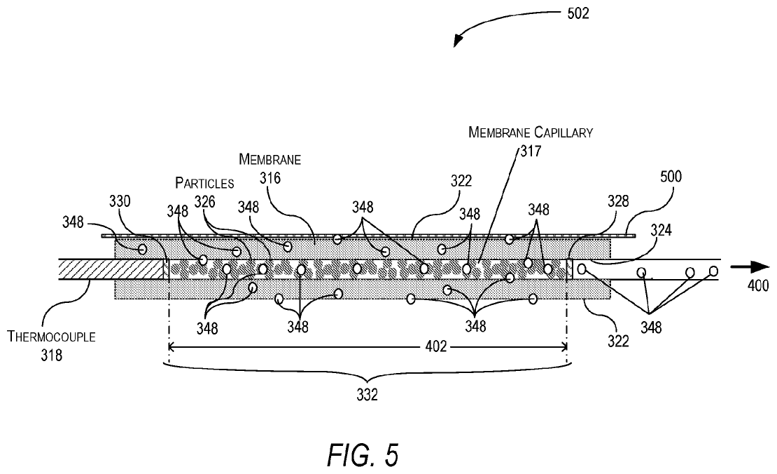

In FIG. 5, the PPMI 300 further includes a structural support-rod 500 physically and externally attached an outer surface 322 of the membrane 316 in accordance with the present disclosure. In this example, as shown in the zoomed-in view 502 (which corresponds to zoomed-in view 360), the structural support-rod 500 may be physically and externally attached to the membrane outer surface 322 optionally at a top of the membrane 316 (as shown) or a bottom of the membrane 316. In this example, the support-rod 500 is configured to maintain the membrane capillary 317 in a straight orientation along the length of the membrane 316. Moreover, the support-rod 500 may be constructed of, for example, metal, ceramic, carbon-based rod, carbon nano-tubes, or other strong, rigid, and straight material.

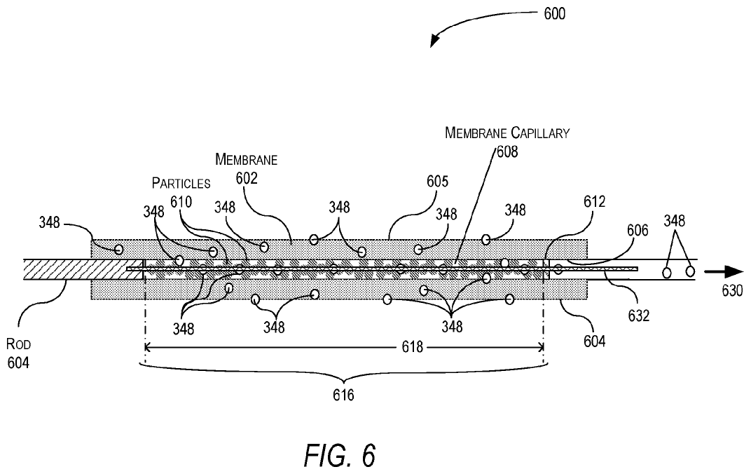

Alternatively, in FIG. 6 is a zoomed-in view 600 of an example of another implementation of the membrane 602 for the PPMI 300 in accordance with the present disclosure. In this example, the PPMI 300 includes the membrane 602 and rod 604 or plug instead of membrane 316 and rod 318, respectively. Similar to the descriptions related to FIGS. 4 and 5, in FIG. 6, the membrane 602 includes is approximately cylindrical in shape having a membrane outer surface 605 and a membrane inner surface 606. The membrane inner surface 606 defines the membrane cavity that is a lumen extending the length of the membrane 602. In this example, the lumen defining the membrane cavity is the membrane capillary 608. Additionally, the membrane capillary 608 is packed with a plurality of particles 610 that are packed against the membrane inner surface 606. The membrane capillary 606 may include a porous restriction 612 and the rod 604 or plug, opposite the porous restriction 612 and along a predetermined length of the membrane capillary 608. In this example, the porous restriction 612 and rod 604 or plug define a particle section 616 within the membrane capillary 608. The porous section 612 and rod 604 or plug are configured to restrict the movement of the plurality of particles 610 within the particle section 616 away from the particle section 616. As in FIGS. 4 and 5, in FIG. 6, the analyte vapors 348 are shown diffusing through the outer surface 605 of the membrane 602 into the membrane capillary 608. The analyte vapors 348 are then evacuated in a direction 630 towards the analyzer 304. In this example, the particle section 616 may be a predetermined length 618 such as, for example, 20 millimeters.

In FIG. 6, the PPMI 300 further includes a structural centering-rod 632 within the membrane capillary 608 in accordance with the present disclosure. In this example, as shown in the zoomed-in view 600 (which corresponds to zoomed-in view 360), the structural centering-rod 632 may be physically inserted into and optionally attached to the membrane inner surface 606. In this example, the centering-rod 632 is configured to maintain the membrane capillary 608 in a straight orientation along the length of the membrane 602. The centering-rod 632 may be constructed of, for example, metal, ceramic, carbon-based rod, carbon nanotubes, or other strong, rigid, and straight material.

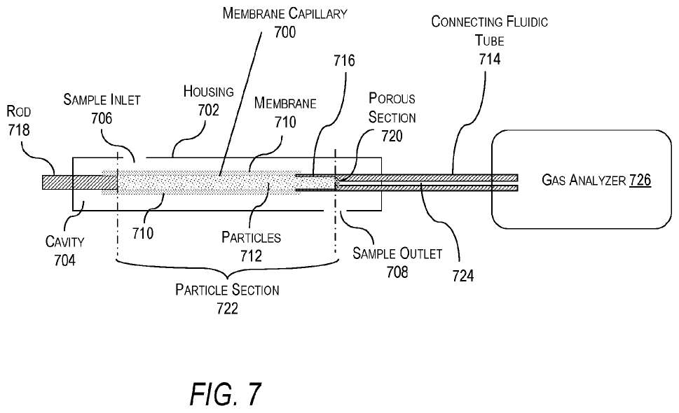

In FIG. 7, a side-view of an example of an implementation of a structural particle-packed membrane capillary 700 (similar to membrane capillaries 317 and 608) is shown in accordance with the present disclosure. In this example, the housing 702 may be a casing that holds the bulk sample matrix that is injected into the cavity 704 of the housing 702 via the sample inlet 706 and ejected via the sample outlet 708. The membrane capillary 700 is within the membrane 710 and is packed with the plurality of particles 712 as shown and as described previously. In this example, the connecting fluidic tube 714 is physically connected to the membrane capillary 700 via a first section 716 of the connecting fluidic tube 714. The plurality of particles 712 are packed within the membrane capillary 700 and the rod 718 or plug and a the porous section 720 at the end of the first section 716 away form the membrane capillary 700. In this example, housing 702 may be casing that holds bulk sample matrix and forces it to flow along the surface of the membrane 710, causing the analyte to dissolve, diffuse through the membrane 710 and evaporate into the membrane capillary 700. The rod 718 may be non-porous rod of plug that may constructed of metal, plastic, or other type of ridge material. As an example, the rod 718 may be, or include, a temperature measuring device such a as a thermocouple. In this example, the plurality of particles 712 may be packed in particle section 722 that includes first section 716 of the of the connecting fluidic tube 714. Moreover, in this example, the connecting fluidic tube 714 may have gas transport tube 724 that is in fluid connection with the gas analyzer 726 has a different size diameter than a tube within the first section 716. In this example, the tube in the first section 716 has a larger diameter that is approximately equal to the diameter of the membrane capillary 700 and is larger than the diameter of the gas transport tube 724. The porous section 720 separates the tube in the first section 716 from the gas transport tube 724 and may be, for example, a sintered material that prevents the particles 712 from passing out of the particle section.

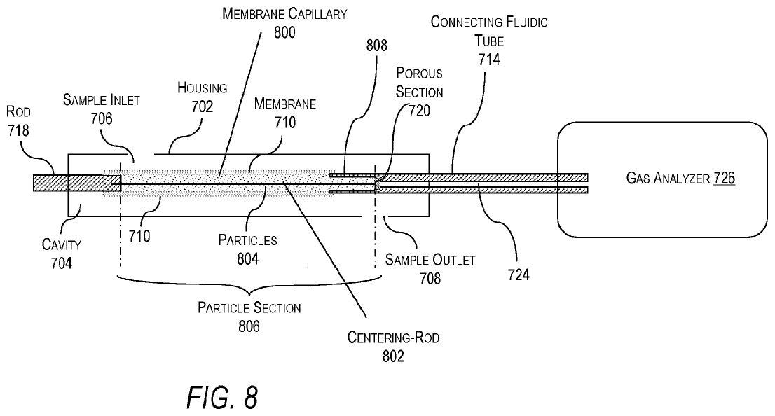

Turning to FIG. 8, a side-view of an example of another implementation of a structural particle-packed membrane capillary 800 (similar to membrane capillary 700) is shown in accordance with the present disclosure. In this example, a centering-rod 802 is shown within the membrane capillary 800. The centering-rod 802 may be a thin rod or fiber providing structural support for the membrane capillary 800 as described previously in relation to centering-rod 632 in FIG. 6. In this example, the plurality of particles 804 are packed within the particle section 806 that includes membrane capillary 800, first section 808 of the of the connecting fluidic tube 714, and the centering-rod 802.

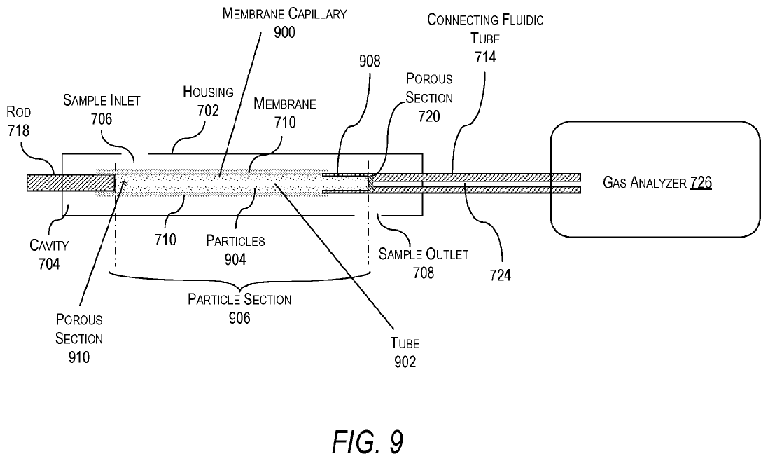

Turning to FIG. 9, a side-view of an example of another implementation of a structural particle-packed membrane capillary 900 (similar to membrane capillaries 700 and 800) is shown in accordance with the present disclosure. In this example, a centering-tube 902 is shown within the membrane capillary 900. The centering-tube 902 may be a thin tube providing structural support for the membrane capillary 900 and improved gas transport. In this example, the plurality of particles 904 are packed within the particle section 906 that includes membrane capillary 900, first section 908 of the of the connecting fluidic tube 714, and the centering-tube 902. In this example, the membrane capillary 900 also includes a second porous section 910 at the other end of the centering-tube 902 opposite the first porous section 720.

In an example of operation, the analytes pass through the second porous section 910 into the centering-tube 902 and then are transported along the centering-tube 902 to the gas transport tube 724 and to the gas analyzer 726. Additionally, other analytes may pass directly from the particle section 906 to the gas transport tube 724 via the first porous section 720 at the first section 908 of the of the connecting fluidic tube 714.

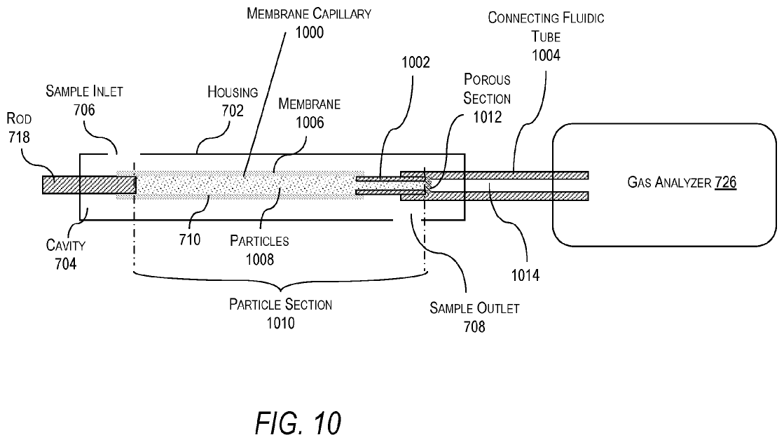

Turning to FIG. 10, a side-view of an example of another implementation of a structural particle-packed membrane capillary 1000 is shown in accordance with the present disclosure. In this example, a first tube 1002 is shown in fluidic communication with the connecting fluidic tube 1004. Additionally, in this example, the membrane 1006 includes the membrane capillary 1006 and slightly overlays the rod 718 or plug and first tube 1002. The membrane capillary 1006 and first tube 1002 are packed with a plurality of particles 1008 defining the particle section 1010 between the rod 718 and a porous section 1012 at the end of the first tube 1002. First tube 1002 extends into the connecting fluidic tube 1004 and may be held together via a bonding material, welding, or union-type fitting (not shown). The first tube has an inner and outer diameter that are smaller than the inner diameter of the gas transport tube 1014 of the connecting fluidic tube 1004. It is appreciated that by utilizing first tube 1002 and gas transport tube 1014 of various diameters, gas conductance (i.e., flow) may be improved.

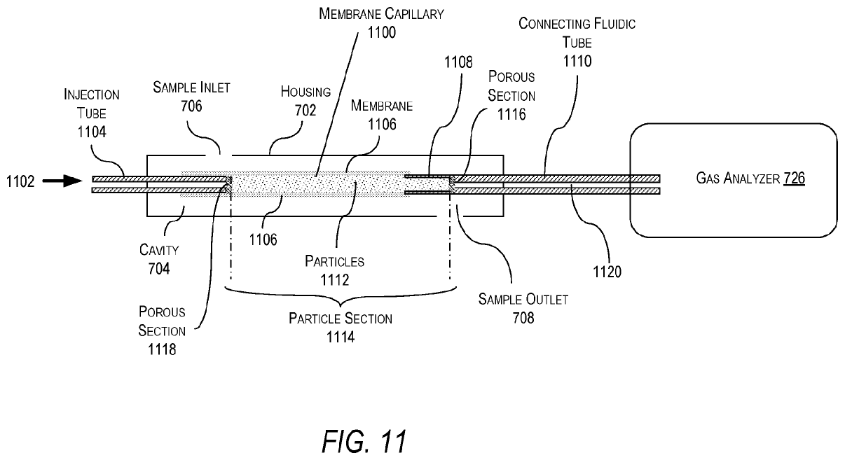

Turning to FIG. 11, a side-view of an example of another implementation of a structural particle-packed membrane capillary 1100 is shown in accordance with the present disclosure. Unlike the earlier examples that utilized evacuation to transport analytes from the membrane capillary 1100 to the gas analyzer 726, in this example the system utilizes a carrier gas 1102 that is injected into an injection tube 1104 to push the analyte through the membrane capillary 1100 to the gas analyzer 726. The carrier gas 1102 may be an inert gas that is predetermined to best transport and not react with the analyte while not interfering with the performance of the gas analyzer 726.

In this example, the membrane capillary 1100 is in the membrane 1106 and overlaps parts of the injection tube 1104 and the part of the first section 1108 of the connecting fluidic tube 1110 that is fluidically connected to the gas analyzer 726. The connecting fluidic tube 1110 is physically connected to the membrane capillary 1100 via the first section 1108 of the connecting fluidic tube 1110. The plurality of particles 1112 are packed within a portion of the membrane capillary 1100 and the first section 1108 of the connecting fluidic tube 1110 defining the particle section 1114 between the first porous section 1116 and a second porous section 1118 opposite the first porous section 1116 along the membrane capillary 1100.

As described earlier, the connecting fluidic tube 1110 may have gas transport tube 1120 that is in fluid connection with the gas analyzer 726 and has a different size diameter than a tube within the first section 1108. In this example, the tube in the first section 1108 has a larger diameter that is approximately equal to the diameter of the membrane capillary 1100 and is larger than the diameter of the gas transport tube 1120. The first porous section 1116 separates the tube in the first section 1108 from the gas transport tube 1120 and may be, for example, a sintered material or other porous material that prevents the particles 1112 from passing out of the particle section. Similarly, the second porous section 1118 separates the injection tube 1104 from the membrane capillary 1100 so as to not allow particles 1112 to escape into the injection tube 1104.

In these examples, the PPMI may be capable of handling very large amounts of hydrostatic pressure while allowing gases to pass to the gas analyzer 304. As an example, the membranes in these examples may be approximately 0.2 mm thick in diameter.

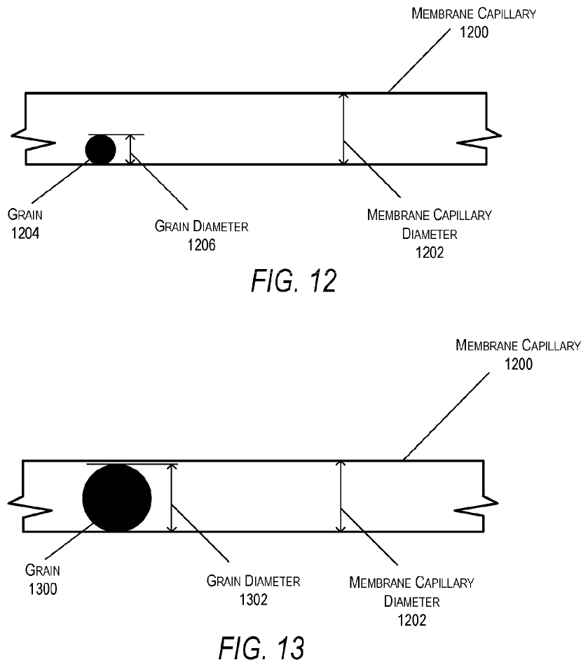

Turning to FIG. 12, a block diagram of the membrane capillary 1200 (or the first tube 716, 808, 908, 1002, or 1108) with the plurality of particles being significantly smaller than the diameter 1202 of the membrane capillary 1200 of the membrane in accordance with the present disclosure. In this example, a single grain 1204 of the plurality of particles is shown having a grain diameter 1006 that is much smaller than the diameter 1202 of the membrane capillary 1200. As an example, the grain diameter 1006 may be 100 micrometers while an example diameter 1202 of the membrane capillary 1200 may be 1500 micrometers.

FIG. 13 is a block diagram of the membrane capillary 1200 with the plurality of particles being approximately equal to the diameter 1202 of the membrane capillary 1200 of the membrane in accordance with the present disclosure. In this example, a single grain 1300 of the plurality of particles is shown having a grain diameter 1302 that is approximately the same but smaller than the diameter 1202 of the membrane capillary 1200 of the membrane.

As an example of implementation, the grains of the plurality of particles may be approximately equal to half the diameter 1202 of the membrane capillary 1200 of the membrane.

In general, the membrane is a means for separating the analyte from the bulk sample matrix. Additionally, the plurality of particles are configured to support the lumen (i.e., membrane capillary) against collapse when the bulk sample matrix has a high pressure. Moreover, the outer surface of the membrane is the means for dissolving, diffusing, and evaporating the analyte through the membrane into the membrane capillary.

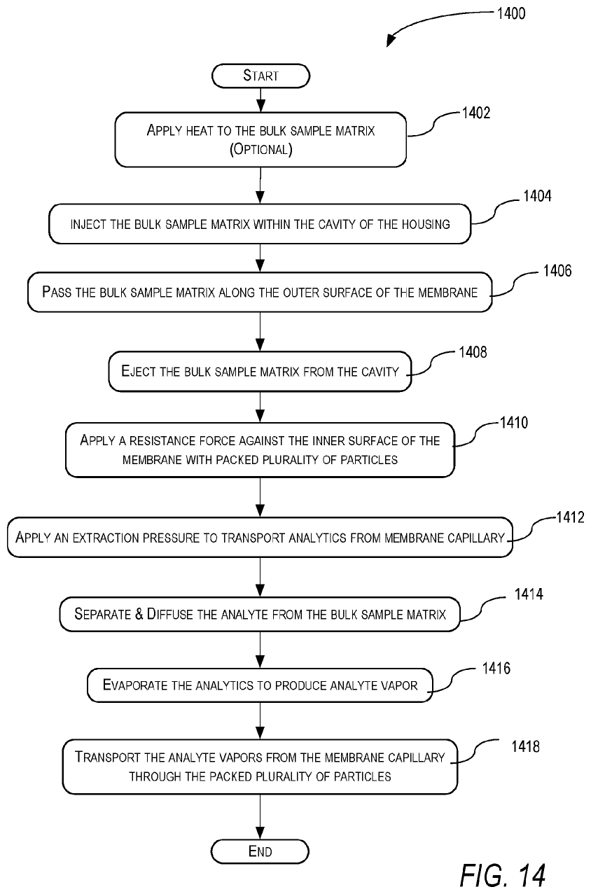

In FIG. 14, a flowchart is shown of an example of implementation of method 1400 performed by the PPMI 300 in accordance with the present disclosure. The PPMI 300 performs the method 1400 for in situ separation of the analyte from the bulk sample matrix. The method 1400 begins by optionally applying heat 1402 to the bulk sample matrix to increase the temperature so as to increase evaporating rates of an analyte. The bulk sample matrix is then injected 1404 into the cavity of the housing via the sample inlet, passed 1406 along the outer surface of the membrane, and ejected 1408 from the cavity via the sample outlet. Simultaneously, while the bulk sample matrix is passed through the cavity, it exerts a pressure on the membrane, in response, the plurality of particles packed in the membrane capillary apply 1410 a resistance force against the inner surface of the membrane that approximately equals the exerted pressure on the membrane from the bulk sample matrix. Approximately simultaneously, an extraction pressure is applied 1412 on the membrane capillary to extract the analytic and transport it towards the gas analyzer.

The method 1400 then separates and diffuses 1414 the analyte from the bulk sample matrix by passing the bulk sample along the surface of the membrane that cause the analyte to dissolve and diffuse through the membrane into the membrane capillary. Then the method 1400 evaporates 1416 the analyte to produce an analyte vapor that is extracted and transported 1418 with the extraction pressure from the membrane capillary through the packed plurality of particles to the gas analyzer. The method 1400 then ends.

In this example, the extraction pressure may be either a vacuum pulled by a vacuum pump towards the gas analyzer or flushing pressure produced by injecting and flushing pressured inert gas(s) to flush the analyte towards the gas analyzer.

As a summary, the disclosure is described by the following clauses.

Clause A. A particle-packed membrane inlet (PPMI) for in situ separation of an analyte from a bulk sample matrix, the PPMI comprising: a membrane configured to separate the analyte from the bulk sample matrix; a membrane capillary within the membrane; and a plurality of particles packed within the membrane capillary, wherein the plurality of particles are configured to support the membrane capillary against collapse when the bulk sample matrix has a high pressure.

Clause B. The PPMI of clause A, further comprising a housing having a cavity, wherein the membrane is within the cavity and the cavity is configured to receive the bulk sample matrix.

Clause C. The PPMI of clause A, wherein the membrane includes an outer surface, and the outer surface of the membrane surface is configured to dissolve and diffuse the analyte through the outer surface and membrane into the membrane capillary.

Clause D. The PPMI of clause A, wherein the plurality of particles includes a plurality of grains.

Clause E. The PPMI of clause D, wherein the grains are a powder or beads.

Clause F. The PPMI of clause D, wherein each grain, of the plurality of grains, has a heterogenous grain size configured to optimize a maximum pressure differential and analyte transport.

Clause G. The PPMI of clause D, wherein each grain of the plurality of grains includes activated grain surfaces configured to interact with the analyte.

Clause H. The PPMI of clause D, wherein the membrane capillary has a capillary diameter and the grains each have a grain diameter that is significantly less than the capillary diameter, wherein the PPMI is configured to maintain a large pressure differential.

Clause I. The PPMI of clause D, wherein the membrane capillary has a capillary diameter and the grains each have a grain diameter that is approximately equal to but less than the capillary diameter, wherein the PPMI is configured to increase conductance.

Clause J. The PPMI of clause A, further including a support-rod physically and externally attached an outer surface of the membrane, wherein the support-rod is configured to maintain the membrane capillary in a straight orientation along a length of the membrane.

Clause K. The PPMI of clause A, further including a centering-rod within membrane capillary, wherein the centering-rod is configured to maintain the membrane capillary in a straight orientation along a length of the membrane.

Clause L. The PPMI of clause A, further including a centering-tube within membrane capillary.

Clause M. The PPMI of clause A, wherein the membrane capillary includes a particle section and a porous restriction, the plurality of particles are packed within the particle section of the membrane capillary, and the porous section is configured to restrict the movement of the plurality of particles away from the particle section.

Clause N. A method for in situ separation of an analyte from a bulk sample matrix, the method comprising: passing the bulk sample matrix along an outer surface of a membrane having a membrane capillary with the membrane, wherein the membrane capillary includes a plurality of particles packed within the membrane capillary, and the plurality of particles are configured to support the membrane capillary against collapse when the bulk sample matrix has a high pressure; separating the analyte from the bulk sample matrix by diffusing the analyte through the membrane into the membrane capillary; and transporting the analyte from the membrane capillary through the packed plurality of particles.

Clause O. The method of clause N, wherein separating the analyte from the bulk sample matrix includes diffusing the analyte with an outer surface of the membrane.

Clause P. The method of clause N, further including injecting the bulk sample matrix within a cavity of a housing, wherein the cavity includes the membrane, wherein transporting the analyte includes evacuating the analyte to an analyzer with a vacuum pump.

Clause Q. The method of clause N, further including injecting the bulk sample matrix within a cavity of a housing, wherein the cavity includes the membrane, wherein transporting the analyte includes flushing the analyte to an analyzer with an injected flushing gas.

Clause R. The method of clause N, further including applying a resistance force against an inner surface of the membrane with the packed plurality of particles, wherein the resistance force resists a pressure produced by the bulk sample matrix on the membrane.

Clause S. A particle-packed membrane inlet (PPMI) for in situ separation of an analyte from a bulk sample matrix, the PPMI comprising: means for separating the analyte from the bulk sample matrix; a lumen within the means for separating; and a plurality of particles packed within the lumen, wherein the plurality of particles are configured to support the lumen against collapse when the bulk sample matrix has a high pressure.

Clause T. The PPMI of clause S, wherein the lumen is a membrane capillary of a membrane.

Clause U. The PPMI of clause T, further including means for dissolving and diffusing the analyte through the membrane into the membrane capillary.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as an example implementations of such techniques.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A particle-packed membrane inlet (PPMI) for in situ separation of an analyte from a bulk sample matrix, the PPMI comprising:
a membrane configured to separate the analyte from the bulk sample matrix;
a membrane capillary within the membrane; and
a plurality of particles packed within the membrane capillary, wherein the plurality of particles are configured to support the membrane capillary against collapse when the bulk sample matrix has a high pressure.

2. The PPMI of claim 1, further comprising
a housing having a cavity,
wherein the membrane is within the cavity and the cavity is configured to receive the bulk sample matrix.

3. The PPMI of claim 1, wherein
the membrane includes an outer surface, and
the outer surface of the membrane surface is configured to dissolve and diffuse the analyte through the outer surface and membrane into the membrane capillary.

4. The PPMI of claim 1, wherein the plurality of particles includes a plurality of grains.

5. The PPMI of claim 4, wherein the grains are a powder or beads.

6. The PPMI of claim 4, wherein each grain, of the plurality of grains, has a heterogenous grain size configured to optimize a maximum pressure differential and analyte transport.

7. The PPMI of claim 4, wherein each grain of the plurality of grains includes activated grain surfaces configured to interact with the analyte.

8. The PPMI of claim 4, wherein the membrane capillary has a capillary diameter and the grains each have a grain diameter that is significantly less than the capillary diameter, wherein the PPMI is configured to maintain a large pressure differential.

9. The PPMI of claim 4, wherein the membrane capillary has a capillary diameter and the grains each have a grain diameter that is approximately equal to but less than the capillary diameter, wherein the PPMI is configured to increase conductance.

10. The PPMI of claim 1, further including a support-rod physically and externally attached an outer surface of the membrane, wherein the support-rod is configured to maintain the membrane capillary in a straight orientation along a length of the membrane.

11. The PPMI of claim 1, further including a centering-rod within membrane capillary, wherein the centering-rod is configured to maintain the membrane capillary in a straight orientation along a length of the membrane.

12. The PPMI of claim 1, further including a centering-tube within membrane capillary.

13. The PPMI of claim 1, wherein
the membrane capillary includes a particle section and a porous restriction,
the plurality of particles are packed within the particle section of the membrane capillary, and
the porous section is configured to restrict the movement of the plurality of particles away from the particle section.

14. A method for in situ separation of an analyte from a bulk sample matrix, the method comprising:
passing the bulk sample matrix along an outer surface of a membrane having a membrane capillary with the membrane, wherein
the membrane capillary includes a plurality of particles packed within the membrane capillary, and
the plurality of particles are configured to support the membrane capillary against collapse when the bulk sample matrix has a high pressure;
separating the analyte from the bulk sample matrix by diffusing the analyte through the membrane into the membrane capillary; and
transporting the analyte from the membrane capillary through the packed plurality of particles.

15. The method of claim 14, wherein separating the analyte from the bulk sample matrix includes diffusing the analyte with an outer surface of the membrane.

16. The method of claim 14, further including
injecting the bulk sample matrix within a cavity of a housing, wherein the cavity includes the membrane,
wherein transporting the analyte includes evacuating the analyte to an analyzer with a vacuum pump.

17. The method of claim 14, further including
injecting the bulk sample matrix within a cavity of a housing, wherein the cavity includes the membrane,
wherein transporting the analyte includes flushing the analyte to an analyzer with an injected flushing gas.

18. The method of claim 14, further including
applying a resistance force against an inner surface of the membrane with the packed plurality of particles,
wherein the resistance force resists a pressure produced by the bulk sample matrix on the membrane.

19. A particle-packed membrane inlet (PPMI) for in situ separation of an analyte from a bulk sample matrix, the PPMI comprising:
means for separating the analyte from the bulk sample matrix;
a lumen within the means for separating; and
a plurality of particles packed within the lumen, wherein the plurality of particles are configured to support the lumen against collapse when the bulk sample matrix has a high pressure.

20. The PPMI of claim 19, wherein the lumen is a membrane capillary of a membrane.

21. The PPMI of claim 20, further including means for dissolving and diffusing the analyte through the membrane into the membrane capillary.
